(19) United States
(12) Patent Application Publication
(10) Pub. No.: US 2026/0152416 A1
(43) Pub. Date: Jun. 4, 2026

(54) SPOIL-BASED LIGHTWEIGHT POROUS BACKFILL FOR PURIFYING WASTE GAS AND WASTEWATER AND METHOD OF USE THEREOF

(71) Applicants: China State Construction Engineering (HongKong) Limited, Hong Kong (CN); Shenzhen University, Shenzhen (CN); China Construction Civil Engineering Co., Ltd., Hong Kong (CN); China State Construction International Holdings Limited, Hong Kong (CN)

(72) Inventors: XIAOHUI SUN, Shenzhen (CN); MING ZHANG, Shenzhen (CN); YUEFENG BI, Shenzhen (CN); CHANGQING CHEN, Shenzhen (CN); XIANGSHENG CHEN, Shenzhen (CN); YUEFU ZHOU, Shenzhen (CN); XI CHEN, Shenzhen (CN); FOCI CHEN, Shenzhen (CN); ZIJUN DONG, Shenzhen (CN); YUE GAO, Shenzhen (CN); HEFU PU, Shenzhen (CN); YI JIANG, Shenzhen (CN); YUNZHE TONG, Shenzhen (CN)

(21) Appl. No.: 19/403,713

(22) Filed: Nov. 28, 2025

(30) Foreign Application Priority Data
Dec. 4, 2024 (CN) 202411774109.0

(51) Int. Cl. C02F 1/28; B01D 53/04; B01D 53/81; C02F 1/68

(52) U.S. Cl. CPC C02F 1/28; B01D 53/0454; B01D 53/81; C02F 1/68; B01D 2259/40084

(57) ABSTRACT

A spoil-based lightweight porous backfill for purifying waste gas and wastewater and a method of use thereof are disclosed. The spoil-based lightweight porous backfill is formed with a plurality of interconnected pores, and the pores are loaded with a purification material. The purification material can purify wastewater and/or waste gas passing through the pores. Compared to traditional closed-cell porous backfills, the spoil-based lightweight porous backfill of the present technical solution is of an open-cell type, possessing strong adsorption capacity. After being loaded with the purification material, it can serve as a multifunctional purification body to provide a purification function for treating low-concentration wastewater and waste gas, thereby realizing an environmental purification function on the basis of providing a backfilling function.

### CROSS-REFERENCE TO RELATED APPLICATIONS

This application claims the benefit of priority to Chinese Patent Application No. 202411774109.0, filed on Dec. 4, 2024, the entire disclosure of which is incorporated herein by reference.

### TECHNICAL FIELD

The present disclosure relates to the technical field of backfills, and more specifically, to a spoil-based lightweight porous backfill for purifying waste gas and wastewater and a method of use thereof.

### BACKGROUND

Conventionally, common construction methods, such as backfilling, mainly include direct backfilling with sand and gravel, soil, or filling with materials such as flowable concrete, foamed concrete, and foamed soil. The primary function of these backfill materials is to fill spaces and bear loads, making them suitable for applications such as roadbeds and building foundations. However, this type of traditional backfill material has significant functional limitations; it only serves filling and load-bearing purposes and lacks environmental pollution control functions, thus being unable to effectively address the demand for pollutant treatment in underground environments.

Specifically, the related art has the following problems:
(1) Single backfilling function: Traditional sand, soil, and flowable backfill materials can only provide a backfilling function for reinforcing roadbeds or building foundations, but they have no positive effect on environmental protection and lack pollution control capabilities. If the backfill material is eroded by pollutants, it often leads to further environmental pollution, and the treatment is difficult and may even cause harmful effects on the ecological environment.
(2) Limitations of groundwater purification technology: For groundwater pollution problems, existing combined structures of permeable reactive barriers and containment walls (such as in CN117023839A) can remove pollutants from groundwater through reactive media. However, their application is limited to groundwater treatment and they do not have a backfilling function. Such structures can only purify groundwater and cannot be used for gas pollution control, lacking flexible application scenarios. Furthermore, this structure does not involve the recycling of waste materials, and once the reactive material in the permeable reactive barrier becomes saturated, replacement and maintenance are extremely difficult. Its structure is complex and heavy, and it is divided into multiple parts, such as a permeable wall and a containment wall, making it difficult to achieve an integrated design.
(3) Deficiencies of porous backfills: Existing materials such as foamed concrete and foamed soil, although having a porous structure, have a low open-porosity and poor connectivity with the external environment, leading to poor water and gas permeability. These materials contribute to reducing the weight of the backfill but do not possess environmental pollution control functions, making them difficult to use in scenarios requiring pollutant purification.

In summary, the backfill materials used in current backfilling technology lack environmental pollution control functions and are suitable for relatively simple application scenarios, failing to meet the demands of modern underground engineering for environmental protection and waste material recycling. These shortcomings have created significant limitations on the application of backfill materials in aspects such as groundwater and gas purification.

### SUMMARY

The main objective of the present disclosure is to provide a spoil-based lightweight porous backfill for purifying waste gas and wastewater and a method of use thereof, aiming to at least solve the technical problem in the related art where backfills lack environmental pollution control functions.

To achieve the aforementioned objective, a first aspect of the present disclosure provides a spoil-based lightweight porous backfill for purifying waste gas and wastewater. The spoil-based lightweight porous backfill is formed with a porous structure, wherein the porous structure comprises a plurality of interconnected pores. The pores are configured to load a purification material, and the purification material is configured to purify wastewater and/or waste gas passing through the pores.

A second aspect of the present disclosure provides a method for using the spoil-based lightweight porous backfill. The method comprises: during the construction of infrastructure, backfilling an available underground space with the spoil-based lightweight porous backfill loaded with a purification material; and purifying wastewater and/or waste gas through the spoil-based lightweight porous backfill.

The spoil-based lightweight porous backfill for purifying waste gas and wastewater and the method of use thereof according to the present disclosure are based on the formation of a plurality of interconnected pores on the spoil-based lightweight porous backfill, with the pores being loaded with a purification material capable of purifying wastewater and/or waste gas passing through them. That is, compared to traditional closed-cell porous backfills, the spoil-based lightweight porous backfill of the present technical solution is of an open-cell type, possessing a larger specific surface area and open porosity. Through the plurality of interconnected pores, a strong adsorption capacity is formed. After being loaded with the purification material, it can serve as a multifunctional purification body to provide a purification function for treating low-concentration wastewater and waste gas, thereby realizing an environmental purification function on the basis of providing a backfilling function.

Furthermore, the present disclosure also has the following beneficial effects:
(1) It breaks through the limitation of traditional backfills having only a single backfilling and mechanical function.
(2) During infrastructure construction, this backfill can be cast and filled, while gas and liquid flow control channels can be simultaneously installed. The space above it can be used for public facilities such as lawns, parks, and basketball courts, achieving a combination of infrastructure construction and environmental purification functions, which is more economically beneficial.
(3) Using a large amount of waste spoil as a raw material not only effectively consumes the spoil and solves the problem of its disposal but also realizes the resource utilization of waste spoil, meeting environmental protection requirements.
(4) It possesses a high open-porosity and connectivity, allowing air and water to permeate through the backfill. The functional materials within it can effectively filter and purify low-concentration pollutants, making it suitable for water and air purification.
(5) The backfill adopts a modular structure. If the loaded material reaches adsorption saturation, it can be updated through excavation and replacement or by reversible adsorption methods. This makes maintenance convenient and enhances the sustainability and economic viability of the purification device.
(6) It achieves an organic combination of backfilling and purification functions. The backfill itself has environmental purification benefits, is harmless, non-polluting, and possesses lightweight and porous characteristics, requiring less material, which reduces the weight of the backfill and construction costs.

In summary, this spoil-based lightweight porous backfill shows significant improvements over existing technologies in terms of structural design, environmental benefits, and resource utilization, possessing the combined functions of backfilling, purification, and environmental protection.

### BRIEF DESCRIPTION OF THE DRAWINGS

To more clearly explain the embodiments of the present application or the technical solutions in the prior art, the drawings required for the description of the embodiments or the prior art will be briefly introduced below. It is apparent that the drawings in the following description are only some embodiments recorded in the present application. For those of ordinary skill in the art, other drawings can be obtained based on these drawings without creative effort.

FIG. 1 is a flowchart illustrating a method of using the spoil-based lightweight porous backfill provided by an embodiment of the present application.

FIG. 2 is a schematic diagram showing the behavior of a conventional porous backfill in water.

FIG. 3 is a schematic diagram showing the behavior of the spoil-based lightweight porous backfill in water according to an embodiment of the present application.

FIG. 4 is a schematic diagram of a scenario for purifying waste gas using the method of the present application (longitudinal channel arrangement).

FIG. 5 is a schematic diagram of another scenario for purifying waste gas using the method of the present application (longitudinal channel arrangement).

FIG. 6 is a schematic diagram of another scenario for purifying waste gas using the method of the present application (longitudinal channel arrangement).

FIG. 7 is a schematic diagram of another scenario for purifying waste gas using the method of the present application (longitudinal channel arrangement).

FIG. 8 is a schematic diagram of a scenario for purifying waste gas using the method of the present application (transverse channel arrangement).

FIG. 9 is a schematic diagram of another scenario for purifying waste gas using the method of the present application (transverse channel arrangement).

FIG. 10 is a schematic diagram of a scenario for purifying wastewater using the method of the present application.

FIG. 11 is a schematic diagram of another scenario for purifying wastewater using the method of the present application.

The implementation of the objectives, the functional features, and the advantages of the present disclosure will be further described with reference to the embodiments and the accompanying drawings.

### DETAILED DESCRIPTION OF EMBODIMENTS

It should be understood that the specific embodiments described herein are merely for the purpose of explaining the present disclosure and are not intended to limit the present disclosure.

It should be noted that related terms such as “first” and “second” may be used to describe various components, but these terms do not limit the components. These terms are only used to distinguish one component from another. For example, without departing from the scope of the present disclosure, a first component may be referred to as a second component, and similarly, a second component may be referred to as a first component. The term “and/or” refers to any one or a combination of the related listed items (“A and/or B” is a way of expressing a selective relationship, which can include three situations: only A, only B, or both A and B).

This embodiment of the present application provides a spoil-based lightweight porous backfill for purifying waste gas and wastewater. The spoil-based lightweight porous backfill is formed with a porous structure, the porous structure comprising a plurality of interconnected pores. The pores are configured to load a purification material, and the purification material is configured to purify wastewater and/or waste gas passing through the pores.

In this technical solution, the plurality of interconnected pores of the spoil-based lightweight porous backfill provide strong adsorption capacity. After being loaded with a purification material, it can serve as a multifunctional purification body to provide a purification function for treating low-concentration wastewater and waste gas, thereby achieving an environmental purification function on the basis of providing a backfilling function.

In an exemplary embodiment, the spoil-based lightweight porous backfill has a large specific surface area, which can enhance adsorption capacity, improve purification efficiency, support multifunctional material loading, and increase the contact reaction space.

In an exemplary embodiment, the open porosity of the spoil-based lightweight porous backfill is 10-80%. The high open porosity provides significant gas and water permeability, allowing the backfill to quickly pass air and water. This characteristic is particularly suitable for wastewater and waste gas purification, ensuring that pollutants can smoothly enter the interior of the backfill and fully contact the purification material within the pores, thereby achieving efficient adsorption and degradation. It also indicates that most of the pores inside the backfill are interconnected, which facilitates the circulation of gases and liquids, further ensuring that the backfill can continuously and effectively purify and filter pollutants in water or air, and adapt to application scenarios requiring good permeability.

Considering the specific surface area and open porosity of the spoil-based lightweight porous backfill as described above, it can be known that the spoil-based lightweight porous backfill of this embodiment is an open-cell type porous backfill, which is significantly different from traditional closed-cell porous backfills. Thus, the spoil-based lightweight porous backfill of this embodiment has better gas permeability, water permeability, and purification functions, making it suitable for various environmental treatment and engineering backfilling applications.

In an exemplary embodiment, the purification material comprises at least one of a metal oxide, an oxidizing agent, a nanomaterial, or a polymer material. Specifically, the spoil-based lightweight porous backfill can form different purification functions by loading different purification materials to achieve the effective removal of various pollutants.

It should be noted that the purification material can also be other materials with purification capabilities, selected according to actual purification needs, which will not be elaborated here.

In an exemplary embodiment, the permeability coefficient of the spoil-based lightweight porous backfill is from 1×10⁻¹ m/s to 1×10⁻⁴ m/s. This range of permeability coefficient provides good water permeability for the backfill, ensuring that pollutants can slowly permeate through the backfill and fully contact the purification material therein, achieving an effective purification treatment effect.

Furthermore, the unconfined compressive strength of the backfill ranges from 300-1500 kPa, indicating good compressive resistance. This strength range can be achieved by adjusting the material ratio, molding process, and curing conditions to meet the bearing requirements of different projects, or it can be adjusted according to the engineering needs.

In an exemplary embodiment, the spoil-based lightweight porous backfill comprises a plurality of types of backfill modules, and different types of backfill modules are loaded with different purification materials.

Specifically, the spoil-based lightweight porous backfill can be designed into multiple types of backfill modules, with each type of module loaded with different purification materials, thereby achieving more efficient purification for different pollutants. This modular design can be flexibly combined with various purification materials according to the characteristics of different pollutants and treatment requirements, achieving multi-level and multifunctional purification effects.

In an exemplary embodiment, the composition of the spoil-based lightweight porous backfill comprises: 100 parts of dry spoil, 20-30 parts of a geopolymer-based curing agent, 65-75 parts of water, 0.185-0.205 parts of a thickening agent, 2.775-6.15 parts of a pore-forming agent, and foam (generally 2%-4% of the total mass). The geopolymer-based curing agent comprises cement, metakaolin, and water glass in a mass ratio of 32:48:20.

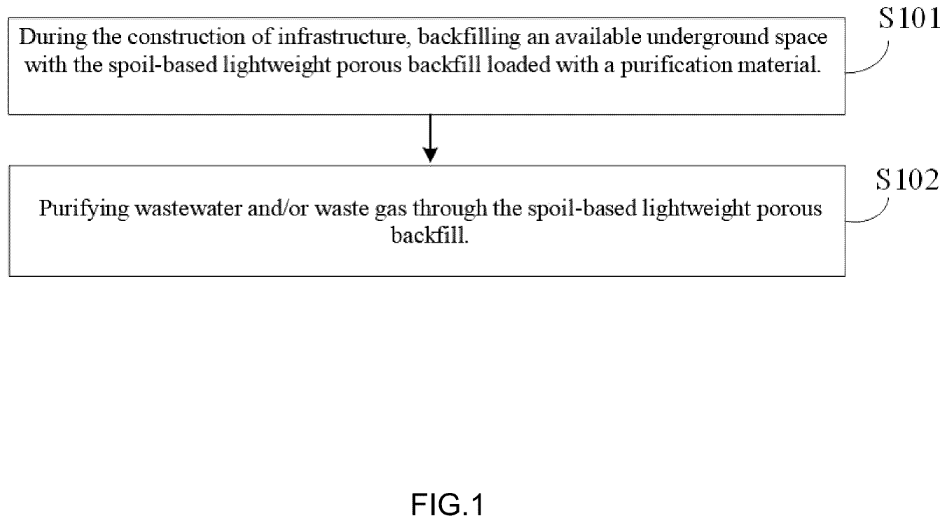

Referring to FIG. 1, this embodiment of the present application also provides a method for using the spoil-based lightweight porous backfill. The method includes the following steps:
Step S101: During the construction of infrastructure, backfill an available underground space with the spoil-based lightweight porous backfill loaded with a purification material.

Step S102: Purify wastewater and/or waste gas through the spoil-based lightweight porous backfill.

In this embodiment, during the construction of infrastructure, the available lower space is fully utilized to backfill with the spoil-based lightweight porous backfill, forming a purification body that does not occupy any additional space. The ground surface space above the backfill can still be used for facilities such as parks and basketball courts, achieving infrastructure with an attached purification function.

In an exemplary embodiment, after the step of backfilling the available underground space with the spoil-based lightweight porous backfill loaded with a purification material, the method further includes: after performing the purification treatment, monitoring the operational state of the purification material. When the operational state of the purification material reaches saturation, the spoil-based lightweight porous backfill is replaced by excavation, or the purification material is treated using a reversible adsorption method.

Specifically, through the aforementioned steps of monitoring the operational state of the purification material, subsequent replacement, and reversible adsorption, it is ensured that the purification material can operate efficiently for a long time, regardless of whether the spoil-based lightweight porous backfill is replaced or the reversible adsorption material is regenerated. This effectively controls pollutants in wastewater/waste gas and provides an environmental purification function, particularly suitable for scenarios such as industrial parks and nature reserves.

It is necessary to further explain here that there is a significant difference between the spoil-based lightweight porous backfill of this embodiment and a conventional porous backfill. As analyzed below:

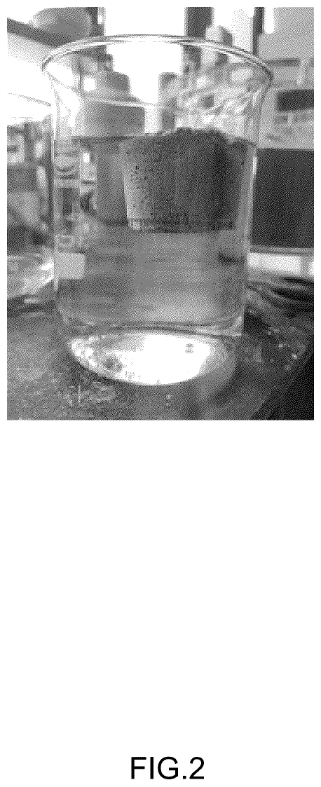

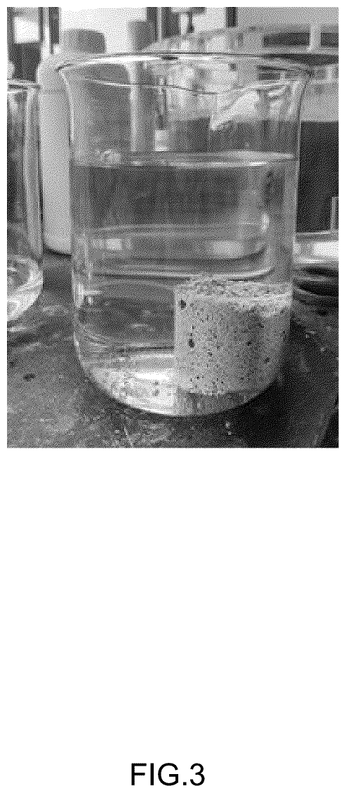

Referring to FIG. 2 and FIG. 3, the difference in behavior in water between two different types of spoil-based porous backfills can be seen through comparison: one is a closed-cell conventional porous backfill (FIG. 2), and the other is an open-cell spoil-based lightweight porous backfill (FIG. 3). FIG. 2 shows that a conventional porous backfill with a density of 600 kg/m³ floats in water, whereas the open-cell spoil-based lightweight porous backfill of this embodiment sinks completely in water.

It can be seen that, firstly, the spoil-based lightweight porous backfill and the conventional porous backfill have differences in material structure. The conventional porous backfill has a closed pore structure, so fluids like water cannot penetrate quickly. In contrast, the spoil-based lightweight porous backfill has an interconnected pore structure, allowing fluids like water to penetrate quickly. Secondly, there is a difference in permeability between the spoil-based lightweight porous backfill and the conventional porous backfill. The pore structure of the spoil-based lightweight porous backfill allows water to permeate freely, which is conducive to providing good water flow-through properties in the purification path, thereby improving contact efficiency with pollutants, making it suitable for permeable purification applications. The closed-cell structure of the conventional porous backfill restricts water penetration, resulting in a lower permeability coefficient, making it unsuitable for scenarios requiring high permeability. Thirdly, there is a difference in application suitability between the spoil-based lightweight porous backfill and the conventional porous backfill. The spoil-based lightweight porous backfill can better achieve water circulation and pollutant removal in a purification system, making it suitable for purification paths that require high permeability and high flow-through. The conventional porous backfill is only suitable as a lightweight filling material and does not have the function of purifying wastewater/waste gas.

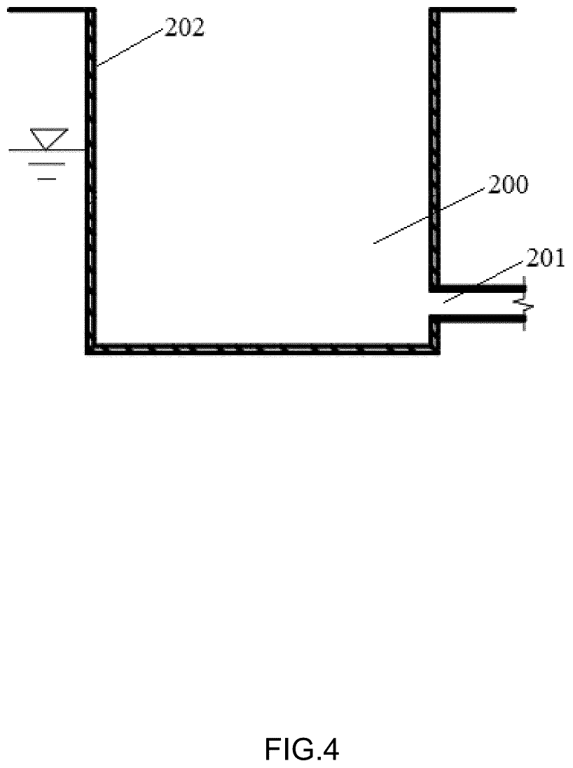

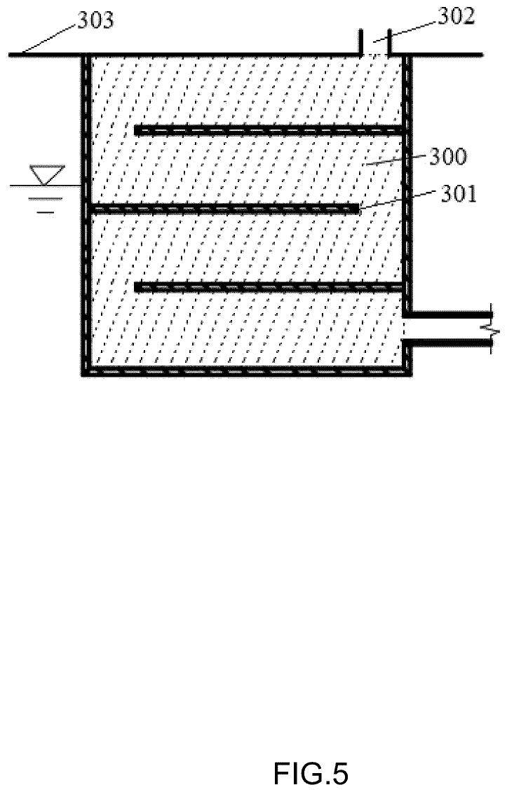

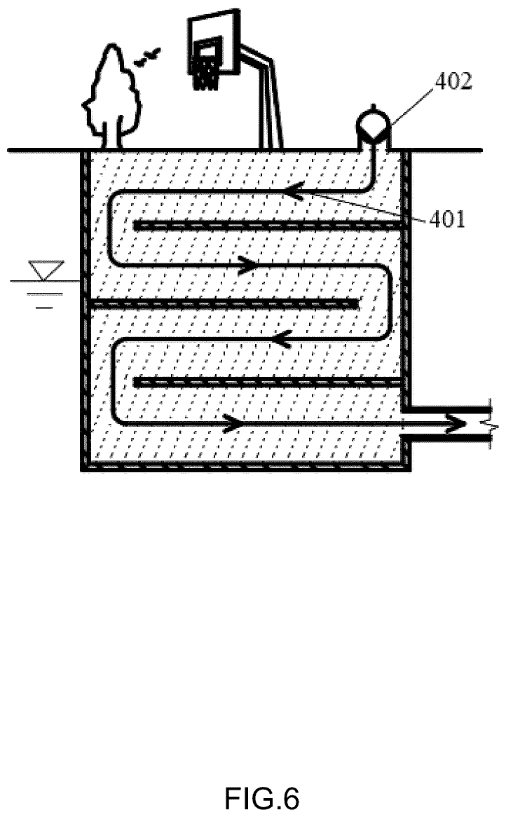

Referring to FIG. 4 through FIG. 7, a scenario diagram (longitudinal channel arrangement) of the application method for purifying waste gas in this embodiment is shown. This application method further includes the following steps:

In the available underground space below the ground surface 303, a construction area 200 is built by an excavator, an outlet 201 is set up, and a seepage-proof barrier layer 202 is constructed.

Channel plates 301 are installed to define a corresponding purification path within the construction area 200. The spoil-based lightweight porous backfill 300 is filled in, and an inlet 302 is constructed.

An upper facility is constructed, and a pressure pump 402 is installed to successively purify the waste gas flowing into the purification path according to the channel flow direction 401.

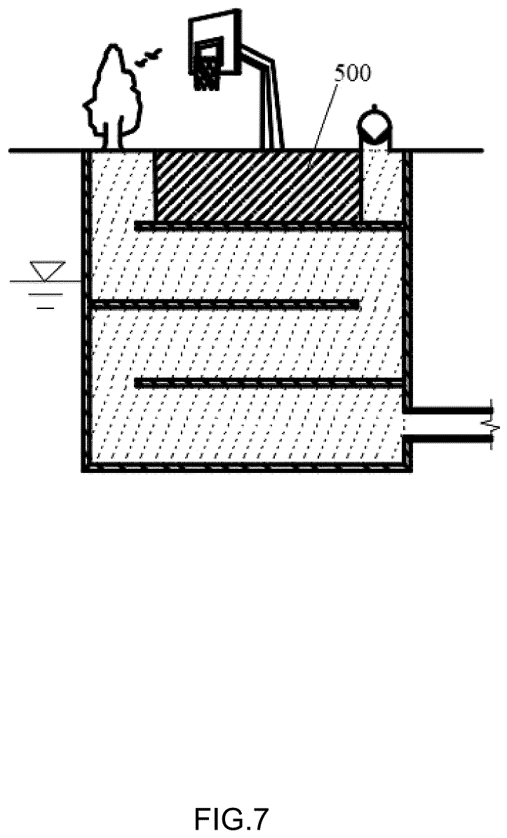

The saturated purification material is replaced or otherwise treated (label 500 in FIG. 7 indicates the spoil-based lightweight porous backfill in which the purification material has reached saturation).

Through the above steps, an efficient construction area can be built below the ground surface 303, and with the driving force of the pressure pump 402, the waste gas is purified stage by stage along the purification path. The entire system is reasonably designed, enabling graded treatment of waste gas or wastewater and supporting regular replacement or regeneration of the purification material, ensuring long-term purification effects.

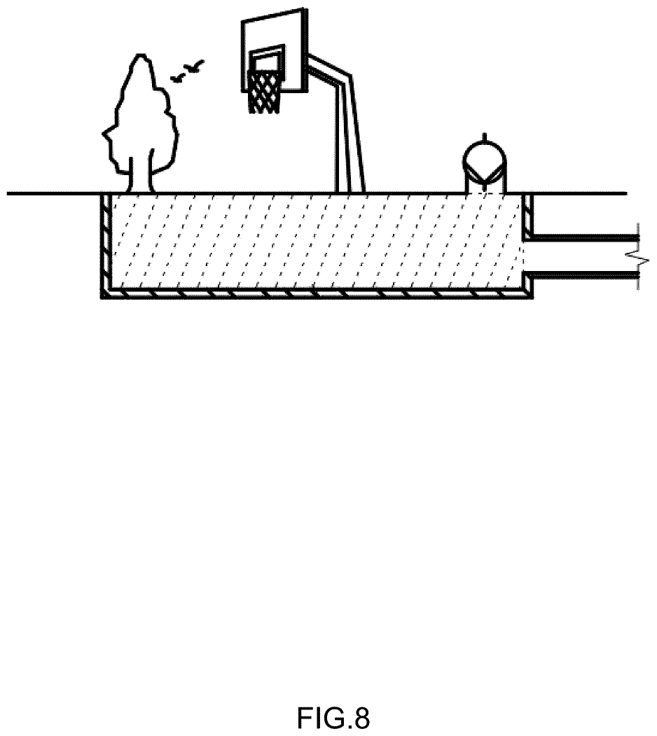

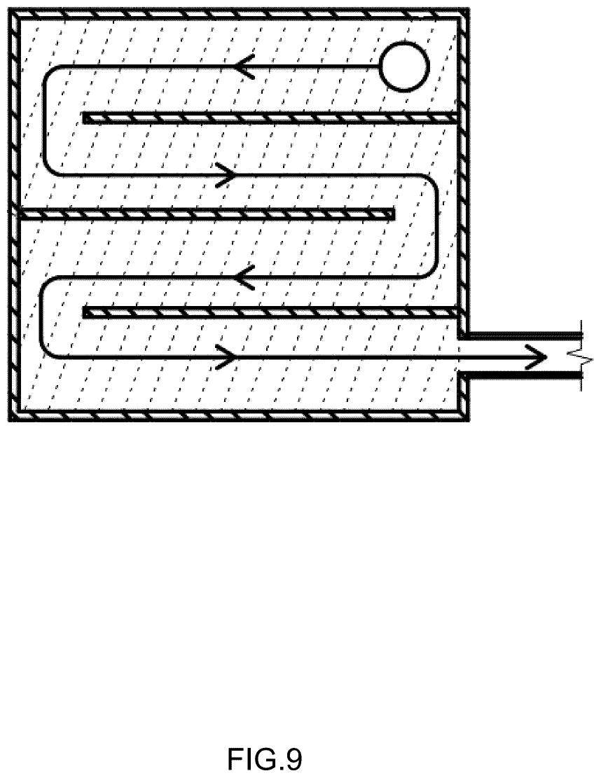

Additionally, referring to FIG. 8 and FIG. 9, a scenario diagram (transverse channel arrangement) of the application method for purifying waste gas is shown.

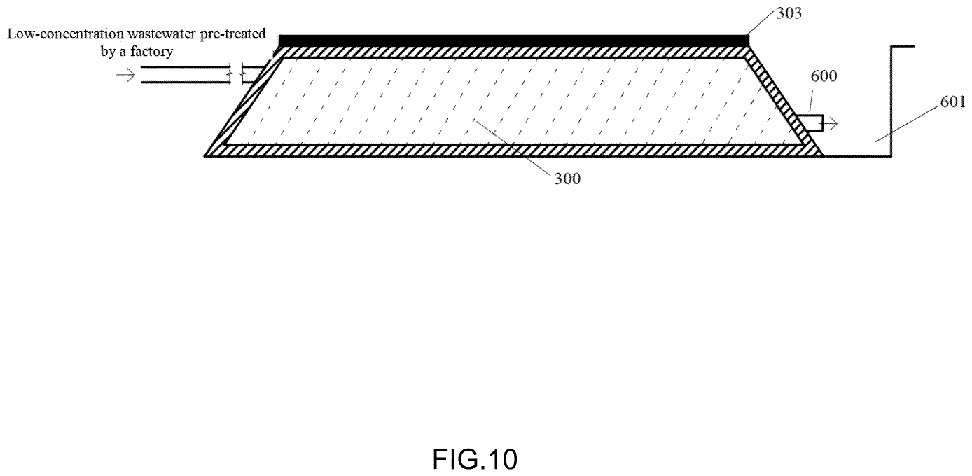

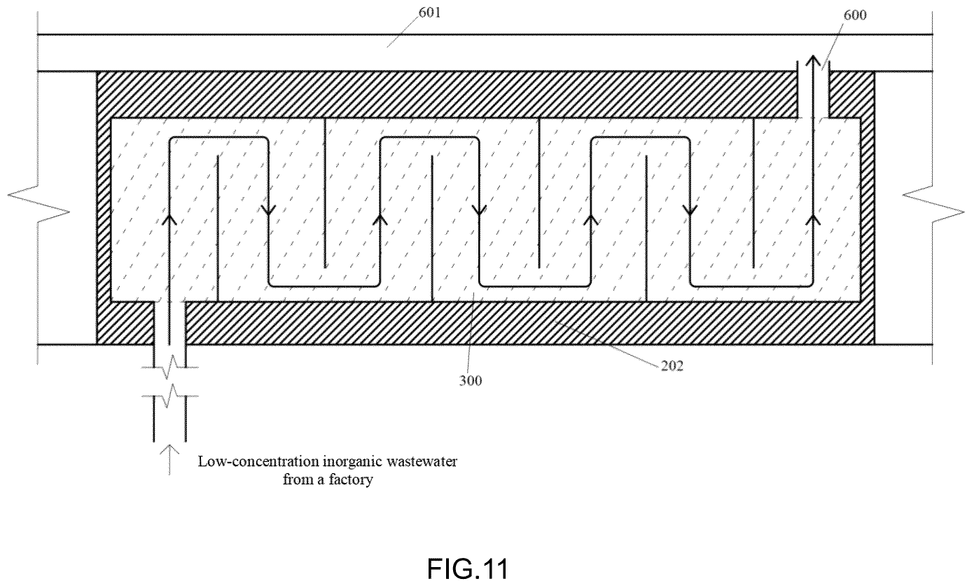

Referring to FIG. 10 and FIG. 11, a scenario diagram of the application method for purifying wastewater in this embodiment is shown. This application method further includes the following steps:

In the available underground space below the ground surface 303, a construction area is built by an excavator, a wastewater outlet 600 is set up, and a seepage-proof barrier layer 202 is constructed.

A corresponding purification path is defined, and the spoil-based lightweight porous backfill 300 is filled in.

Low-concentration wastewater, pre-treated by a factory, that flows into the purification path is successively purified and then discharged to a drainage channel 601.

Through the above steps, a purification construction area is built in the underground space below the ground surface 303 for treating the incoming low-concentration wastewater.

In summary, the spoil-based lightweight porous backfill for purifying waste gas and wastewater and its application method provided by this embodiment is an open-cell type, possessing a large specific surface area and open porosity. It also forms a plurality of interconnected pores, which are loaded with a purification material. In this technical solution, the plurality of interconnected pores of the spoil-based lightweight porous backfill provide strong adsorption capacity. After being loaded with the purification material, it can serve as a multifunctional purification body to provide a purification function for treating low-concentration wastewater and waste gas, thereby achieving an environmental purification function on the basis of providing a backfilling function.

Furthermore, this embodiment of the present application also has multiple advantageous effects:
(1) Efficient purification function: Due to the high open porosity and permeability of the backfill, its structure can be loaded with various purification materials, making it suitable for the purification of waste gas and low-concentration wastewater.
(2) Efficient use of lower space with attached purification function: During infrastructure construction, this backfill can make full use of developable underground space without occupying additional surface space. Meanwhile, its upper part can still be used for facilities such as parks and basketball courts, thereby achieving multifunctional development of both surface and underground spaces and providing an environmental purification function in addition to meeting public facility needs.
(3) Carbon sequestration and strength enhancement: The backfill itself is alkaline and can absorb carbon dioxide from the air, achieving a carbon sequestration effect. When the backfill is used for roadbeds, after adsorbing carbon dioxide to saturation and undergoing carbonation, its strength is enhanced, thereby improving the support and durability of the roadbed, providing a good structural reinforcement effect.
(4) Convenient maintenance and regeneration: The modular design of the backfill allows for local excavation and replacement of the purification material after it becomes saturated. Alternatively, reversible adsorption techniques can be used for material regeneration, ensuring the long-term stable operation of the purification system and reducing maintenance costs.
(5) Resource utilization of spoil and green environmental protection: This backfill uses a large amount of spoil as its main raw material, effectively realizing the resource utilization of spoil. The backfill itself is lightweight and porous, saving a large amount of building materials and reducing construction costs. At the same time, its green and environmentally friendly characteristics are in line with the requirements of sustainable development, providing an innovative solution for the recycling of waste materials.

It should be noted that for the foregoing method embodiments, for the sake of simple description, they are all expressed as a series of action combinations. However, those skilled in the art should know that the present application is not limited by the described sequence of actions, because according to the present application, some steps can be performed in other orders or simultaneously. Secondly, those skilled in the art should also know that the embodiments described in the specification are all exemplary embodiments, and the actions and modules involved are not necessarily required by the present application.

In the above embodiments, the descriptions of each embodiment have their own focus. For parts that are not detailed in a certain embodiment, reference can be made to the relevant descriptions of other embodiments.

The above are only the exemplary embodiments of the present disclosure and do not thereby limit the patent scope of the present disclosure. Any equivalent structural or equivalent process transformation made by using the content of the description and drawings of the present disclosure, or directly or indirectly applied in other related technical fields, are similarly included within the patent protection scope of the present disclosure.

What is claimed is:

1. A spoil-based lightweight porous backfill for purifying waste gas and wastewater, comprising:
a porous structure comprising a plurality of interconnected pores;
wherein the pores are configured to load a purification material, and the purification material is configured to purify wastewater and/or waste gas passing through the pores;
wherein an open porosity of the spoil-based lightweight porous backfill is 10-80%;
wherein the purification material comprises at least one of a metal oxide, an oxidizing agent, a nanomaterial, or a polymer material;
wherein the spoil-based lightweight porous backfill comprises 100 parts of dry spoil, 20-30 parts of a geopolymer-based curing agent, 65-75 parts of water, 0.185-0.205 parts of a thickening agent, and 2.775-6.15 parts of a pore-forming agent;
wherein the geopolymer-based curing agent comprises cement, metakaolin, and water glass in a mass ratio of 32:48:20.

2. The spoil-based lightweight porous backfill for purifying waste gas and wastewater according to claim 1, wherein the spoil-based lightweight porous backfill is formed into a plurality of types of backfill modules, and different types of backfill modules are loaded with different purification materials.

3. The spoil-based lightweight porous backfill for purifying waste gas and wastewater according to claim 1, wherein a permeability coefficient of the spoil-based lightweight porous backfill is from 1×10⁻¹ m/s to 1×10⁻⁴ m/s, and its unconfined compressive strength is from 300-1500 kPa.

4. A method of use for the spoil-based lightweight porous backfill of claim 1, comprising:
backfilling an available underground space with the spoil-based lightweight porous backfill loaded with the purification material during construction of infrastructure; and
purifying wastewater and/or waste gas through the spoil-based lightweight porous backfill.

5. The method of use according to claim 4, wherein, after the step of backfilling the available underground space with the spoil-based lightweight porous backfill loaded with the purification material, the method further comprises:
monitoring an operational state of the purification material after performing the purification;
when the operational state of the purification material reaches saturation, replacing the spoil-based lightweight porous backfill by excavation or treating the purification material using a reversible adsorption method.
